(19) United States
(12) Patent Application Publication
(10) Pub. No.: US 2010/0142004 A1
(43) Pub. Date: Jun. 10, 2010

(54) Method for Embedding a Message into a Document

(76) Inventors: Shantanu Rane, Cambridge, MA (US); Avinash Laxmisha Varna, Greenbelt, MD (US); Anthony Vetro, Arlington, VA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/329,869

(22) Filed: Dec. 8, 2008

(51) Int. Cl. G06K 15/00; B42D 15/00

(52) U.S. Cl. 358/3.28; 283/72

(57) ABSTRACT

A method that embeds a message into a document containing a number of glyphs and extracts said message from a degraded version of said document. Each symbol of the message is represented as a geometrical relationship of two discrete sets of pixels, in which the pixels in each set are adjacent. The pixels associated with the glyphs selected from the document are combined with the discrete sets of pixels to produce modified glyphs that contain the embedded message.

### FIELD OF THE INVENTION

This invention relates generally to embedding messages into documents, and more particularly to embedding and extracting messages from glyphs in the documents.

### BACKGROUND OF THE INVENTION

Watermarks

Watermarks are often embedded in documents as messages. The embedded messages can be used for security, privacy, and copyright protection to give a few examples.

Watermarking for paper “hard-copy” documents differs from electronic “soft-copy” watermarking. For soft-copy documents, all operations, namely watermark insertion, document copying, document degradation and watermark extraction occurs in the digital domain, e.g., in PDF or Postscript documents. On the contrary, in the case of hard-copy documents, document degradation occurs in the hard-copy domain. This can degrade the watermark, or make the watermark otherwise unusable. Watermarks in hard-copy documents can be degraded when the documents are copied, scanned, faxed or otherwise manipulated. Hard-copy watermarks can also be physically damaged, e.g., crumpled, or torn intentionally or unintentionally.

Glyphs

A glyph, as defined herein, is a fundamental graphic object. The most common examples of glyphs are text characters or graphemes. Glyphs may also be ligatures, that is, compound characters, or diacritics. A glyph can also be a pictogram or ideogram. The term glyph can also be used for a non-character, or a multi-character pattern. As used herein, a glyph is some arbitrary graphic shape or object.

Message Embedding Challenges

There are number of conventional methods for embedding hidden messages in media signals, e.g., images, video, and audio. However, embedding hidden messages inside both soft- and hard-copy documents is difficult.

In hard-copy documents, the glyphs are usually structured. Thus, even small changes to the structure, e.g., spacing and orientation, can be detected by the human visual system. Accordingly, changes to hard-copy documents, for the purpose of invisible watermarking, must necessarily be very small. Furthermore, a hard-copy document can undergo physical deteriorations when it changes hands, is torn or folded. A message that would have been detectable in an electronic version of the document can be lost when the printed document is photocopied or scanned, e.g., subtle changes in gray level will be lost after copying.

Conventional Message Embedding Methods

Some conventional message embedding methods treat a text document as an image and use image-based watermarking techniques. One disadvantage of these methods is that they do not work well with printers, which primarily operate on bitmapped representations of individual text characters or half-tone representations of colors and shades.

Another conventional method slightly alters the color of characters such that the difference is imperceptible to the eye, but can be sensed by a scanner. Because the embedded message is invisible, it is difficult to alter the watermark. However, the disadvantage of this method is that the small differences in color or gray-level are easily lost when the document is copied.

Another method modulates the distance between individual letters or between individual words or between successive lines of text. At low embedding rates, this method is nearly invisible to the eye, and survives copying. However, the disadvantage of this method is that at high embedding rates, the non-uniform distances between the characters, or words or lines becomes visible and annoying.

Another method employs the effect of dithering by placing a checkerboard-like black-and-white pattern of dots on the border of entire character, making the entire character narrower or wider than normal. However, this method is not robust to photocopying because the individual dot patterns would be too small to be retained after photocopying.

Another method embeds a pseudo random pattern of dots in the background of the document irrespective of the location of the text. The dots, although relatively unobtrusive, can still be easily removed. Further, the dots are small and may not survive more than one round of photocopying.

Dirty Paper Coding

Dirty Paper coding (DPC), also referred to as “Writing on Dirty Paper” is a method of encoding a message in the presence of some side information. The side information is known to the encoder but not to the decoder. The side information generally consists of some interfering signal at the encoder. The encoder's task is to encode the desired message in such a way that the decoder must be able to recover the message without possessing any knowledge of the interfering signal. In other words, the decoder should be able to read a message from a “dirty” document without a priori knowledge of which portion constitutes the actual message and which portion is noise. Hence the name “Dirty Paper Coding.” DPC is traditionally used in digital and wireless communications with multiple antennas, with popular examples being Costa preceding, Tomlinson-Harashima precoding and vector perturbation.

In the context of watermarking based on DPC, the watermark plays the role of the message to be encoded while the document plays the role of the interfering signal at the encoder.

### SUMMARY OF THE INVENTION

It is an object of the subject invention to provide a method for embedding a message in soft-copy and hard-copy documents as a watermark.

It is further object of the invention to provide such method that the message will be unobtrusive to a reader of the document.

It is further object of the invention to provide such method that the embedded message could be relatively large.

It is further object of the invention to provide such method that the embedded message extraction will be resistant to physical deteriorations of the document.

It is further object of the invention to enable physical copying of the document without destroying the message.

The subject invention resulted from the realization that symbols of a message to be embedded in a document could be represented as geometrical relationships of two discrete sets of pixels. Furthermore, when pixels associated with glyphs in the document are combined with at least the two discrete sets of pixels, the message is embedded in the document and the message is unobtrusive to human eye, and resistant to physical deterioration and photocopying.

Embodiments of the invention are based on dirty paper coding using side information. The method treats the document to be watermarked as known interference at the encoder. Operations such as printing, copying and scanning of the watermarked document are considered as realizations of a noisy channel. The watermark itself is treated as a message, which must be transmitted in the presence of the known interference and unknown noise.

To combat the noisy channel, an error correcting code is applied to the watermark before it is embedded in the document. The embedding operation can be performed at a print server or email server or inside a printer or inside a fax machine or in a processor where the message is generated. An estimator can perform error correction decoding on a copy of the document in order to retrieve the embedded message.

### BRIEF DESCRIPTION OF THE DRAWINGS

FIG. 1 is a block diagram of a method for embedding a message into a document according to embodiments of invention;

FIG. 2 is schematic of normal size and enlarged glyphs with embedded symbols of the message according to the embodiments of the invention;

FIG. 3 is a block diagram of a packet including symbols according to the embodiments of the invention;

FIG. 4 is a block diagram of a method for extracting the message from the document according to the embodiments of the invention; and

FIGS. 5A-5E are enlarged schematics of embedded messages according to the embodiments of the invention.

### DETAILED DESCRIPTION OF THE PREFERRED EMBODIMENT

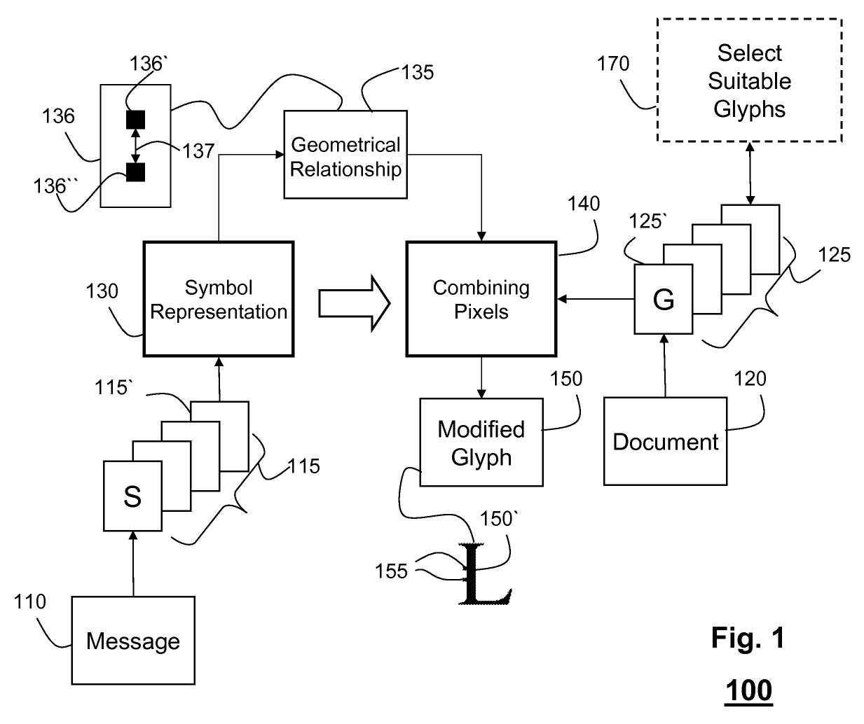

FIG. 1 shows a method 100 for embedding a message 110 in a document 120 according to embodiments of our invention. The message includes a set of symbols 115. A symbol 115 of the message 110 is represented 130 as a geometrical relationship of two discrete sets of pixels 135. The two discrete sets of pixels 136 is a visual example of the geometrical relationship 135. Pixels in each set 136 are adjacent to each other. The geometrical relationship 135 could include a distance 137 between the two discrete sets of pixels 136′ and 136″, and a relative angular position of the two discrete sets of pixels 136′ and 136″. The angular position is determined in relation to the document 120. For example, the relative angular position could be horizontal, vertical, or combinations thereof. Please note that it is possible to use more than two discrete sets of pixels to represent the symbol 115′. The angular position can also be defined according to a coordinate system of the document, where the coordinates of the top-left pixel is the origin (0, 0).

The geometrical relationship 135 could also include size and shape of each of the two discrete sets of pixels 136′ and 136″. For example, if two discrete sets of pixels 136′ and 136″ are formed with two rows having two pixels in each row, then the size of each set is 2×2, and the shape is square. The size of the sets 136 is usually small compared to the size of the glyphs. The size and shape of the sets 136 are selected to trade off error resiliency and perceptibility. The size and shape of the sets 136 are also dependent upon the degradations that the document is expected to undergo. For example, in the case of photocopy degradation, the size and shape is determined based on the observation that local dark perturbations in shape become smaller, while local light perturbations in shape become larger. Note that the size and shape of the sets 136 can be selected arbitrarily for a given font and pica of glyphs 125 in the document 120.

Additionally, the symbol 115′ could also be represented with intensities of each pixel in the sets 136. For example, the intensities of pixels in the sets 136 could be equal to one. Alternatively, the intensities could be zero, or other values between zero and one.

The document 120 includes a set of glyphs 125. A glyph 125′ is an element of the set of glyphs 125. Pixels associated with the glyph 125′ are combined 140 with the two discrete sets of pixels, e.g., the sets 136, to produce a modified glyph 150 in the document 120, such that the symbol 115′ of the message 110 is embedded in the modified glyph 150. Modified glyph 150′ is a visual example of the modified glyph 150 with embedded symbol 115′.

Typically, the combining pixels step 140 modifies, e.g., merges, replaces, or maps intensities of the corresponding pixels associated with the glyph 125′ according to pixels from the two discrete sets of pixels 136. The corresponding pixels, e.g., pixels 155, have geometrical relationship corresponding to the geometrical relationship 135. Thus, the corresponding pixels are organized into two set of pixels having, e.g., the same size, shape, distance between sets, and orientation as the two discrete sets of pixels 136.

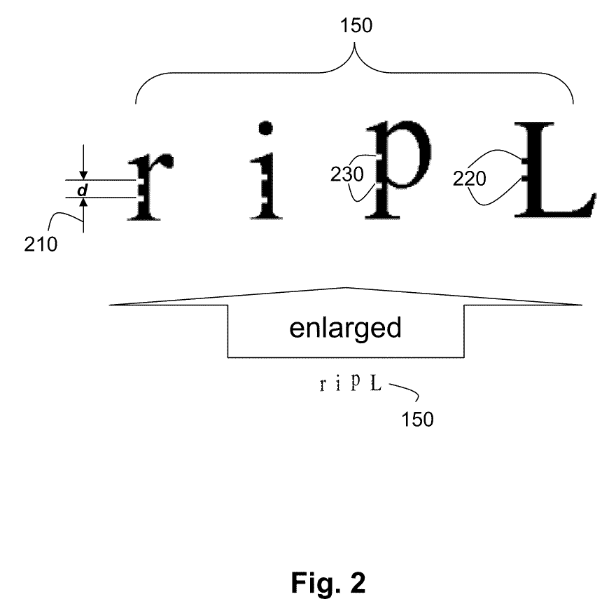

The corresponding pixels are associated with glyphs 125 of the document 120, e.g., the glyph 125′. For example, as shown on FIG. 2, corresponding pixels 230 were internal to a shape of the glyph 125′ and were combined with the pixels having zero intensities of the sets 136 to produce the modified glyph 150. Alternatively, corresponding pixels 220 are external to the shape of the glyph 125′, but at least one pixel in each set of corresponding pixels 220 is immediately adjacent to pixels forming the shape of the glyph 125′. Usually, the corresponding pixels are bordering either vertical or horizontal strokes of glyphs 125 of the document 120.

In the preferred embodiment, the distance 210 determines the embedded symbol. The distance 210 could be computed, e.g., between the edges or the centers of the two discrete sets 136.

In one embodiment, we select 170 the glyph 125′ from the set of glyphs 125 of the document, such that the glyph 125 is suitable for embedding the symbol 115′. For example, a shape of the glyph 125′ should have at least one stroke having a length of at least l pixels and a width of at least w pixels. The values of l pixels w pixels depends on the resolutions, and font and pica of the glyphs. In one embodiment, l is greater than 28 pixels and w is greater than 5 pixels.

The method 100 uses dirty paper coding (DPC) wherein the message is encoded as side information, while treating the document as known interference. Subsequent operations, such as printing, scanning, and copying of the modified document, are treated as realizations of a noisy channel. The method makes the modified document resilient to the noisy channel. This means that the message can be extracted reliably even after noisy operations.

The result of embedding the message into the document is a modified document stored on a readable media, e.g., printed on a paper, stored on a hard drive or displayed on a computer screen. The modified document includes at least one glyph, and has at least two discrete sets of pixels engaged in a bias relationship with pixels associated with the glyph, such that a geometrical relationship of the two discrete sets of pixels is suitable for extracting a symbol of a message embedded in the document.

Because the size of the sets 136 is typically small compared to the size of the glyphs, embedded message is usually unobtrusive to a reader of the document. The size of the sets 136 is selected to trade off error resiliency and perceptibility. It is possible to embed several symbols into one glyph. However, if the document includes a relatively large number of glyphs, the embedded message could be correspondingly large as well. Furthermore, the embedded message is detectable due to the contrast between pixels intensities of the sets 136 and bordering the sets 136 pixels of the glyphs with embedded symbols of the message. Thus, the embedded message is resistant to physical deteriorations of the document and extraction of the message is possible even after one or several instances of photocopying of the document.

Message Extraction

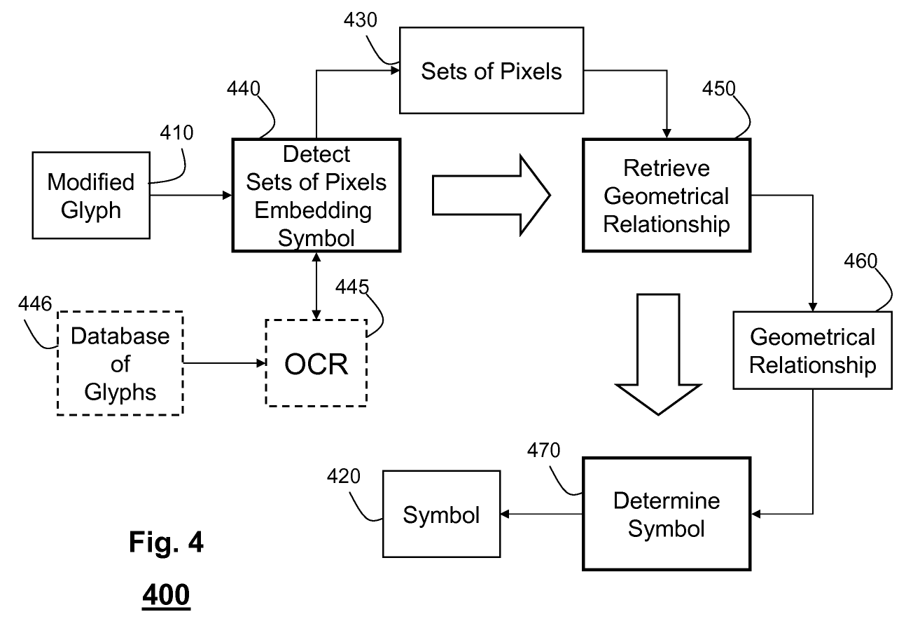

FIG. 4 shows a method 400 for extracting a symbol 420 from a modified glyph 410 with embedded symbol. The modified glyph 410 can be read from the original document 120, or from a copy, e.g., result of printing, scanning, emailing, photocopying, faxing, of at least part of the document 120.

The two discrete sets of pixels 430 embedding the symbol 420 are detected 440 among pixels of the modified glyph 410. The symbol 420 is determined 470 based on the geometrical relationship 460 retrieved 450 from the two discrete sets of pixels 430.

In one embodiment, we extract the embedded message from a printed version of the document. We first scan the document and convert it into a grayscale image Y. We determine the locations of glyphs with vertical strokes of length at least l′ and width at least w′ pixels. The values of l′ and w′ are chosen based on the values of l, w, the printing resolution and the scanning resolution. To identify such glyphs, we first obtain a binary image Y_{b} from the grayscale image Y by performing a thresholding operation. To ensure that we detect characters whose strokes have been modified with some pixels, we first perform a morphological closing operation on Y_{b} and then perform erosion with a rectangular structuring element of size l′×w′. Once the locations of the vertical strokes have been determined, we identify the symbol embedded in that stroke by correlating the corresponding stroke from the grayscale image Y with each of the candidate symbols and choosing the symbol with the highest correlation.

One embodiment of our invention optionally uses an OCR engine 445. The modified glyph 410 is recognized by the OCR engine 445 and compared with corresponding unmodified glyph from database 446 assisting to detect 440 the likely location of the two discrete sets of pixels 430 embedding the symbol 420.

Packet of Symbols

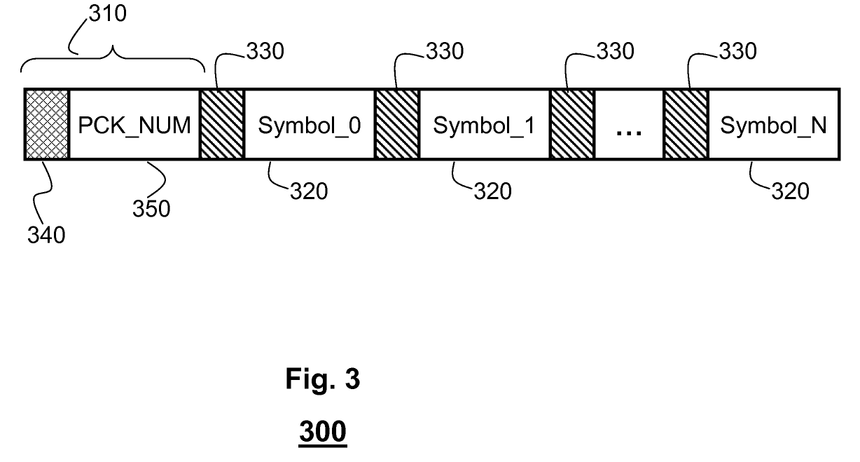

To facilitate error detection and correction, the symbols in the message can be optionally structured as a packet 300, as shown in FIG. 3. One or more “packetization symbols” are inserted into a message to be embedded inside a document, thus symbols of the message are grouped into a packet 300. The packet 300 includes a header 310, a set 320 of N symbols (Symbol_i) of the message, and synchronization symbols 330. The header includes a “begin packet” symbol 340 followed by a packet number symbol (PCK_NUM) 350. The number of symbols in the packets determines the error resiliency of the embedding.

In one embodiment, message extraction method identifies the “begin packet” symbol and then extracts the packet number symbol 350. If the packet number symbol cannot be extracted, then the symbols 320 embedded in the packet are treated as erasures. Otherwise, the symbols 320 are extracted, possibly with errors, using the synchronization symbols 330. If the number of synchronization symbols is not equal to N, the entire packet 300 is considered to be erased. Erasures and errors can be corrected using an error correcting code, e.g., a Reed-Solomon decoder. Any other error correcting code can be used. Skilled artisan will recognized that the architecture places no restriction on whether the code has an algebraic hard-decision decoder or a graph-based soft-decision decoder. The choice of the error correcting code can be dependent upon the distribution of decoding errors, convenience of decoding, and the computational complexity that is allowed in the message extraction module. The rate of the error correcting code can be selected based on the amount of degradation that the document is expected to undergo and the level of noise robustness desired.

### EFFECT OF THE INVENTION

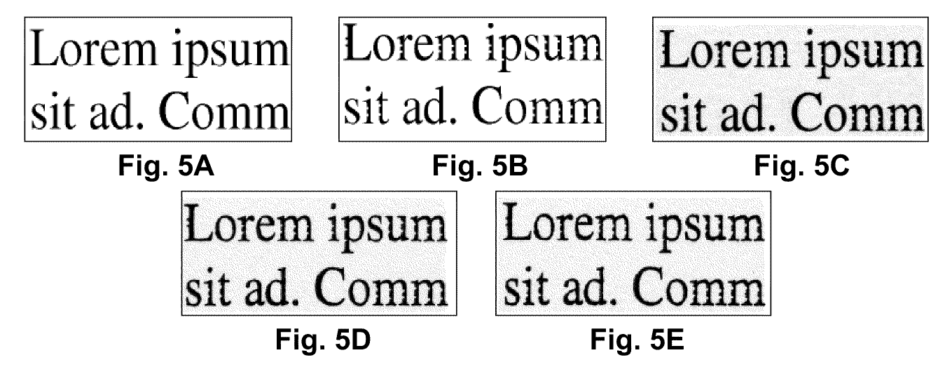

FIGS. 5A-5E show example messages embedded in the hard-copy document. The document is printed at 12 pt in “Times New Roman” font at a resolution of 600 dots per inch (dpi). Prior to printing, we add or remove two groups of pixels as described above along the edges of vertical strokes of length l is greater than twenty-eight pixels, and the width w of a stroke is greater than five pixels. The document is copied, and then scanned at the same resolution. FIG. 5A shows the original document. FIG. 5B shows the document with an embedded message. FIG. 5C shows the scanned document after printing, and FIGS. 5D and 5E the scanned document after one and two copying operations respectively.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for embedding a message into a document including a set of glyphs, comprising:
representing a symbol of a message to be embedded in a document as a geometrical relationship of two discrete sets of pixels, in which the pixels in each set are adjacent; and
combining pixels associated with a glyph in the document with the two discrete sets of pixels to produce a modified glyph in the document, wherein the symbol of the message is embedded in the modified glyph.

2. The method of claim 1, wherein the geometrical relationship includes a Euclidean distance between the two discrete sets of pixels.

3. The method of claim 1, wherein the geometrical relationship includes a size of each of the two discrete sets of pixels.

4. The method of claim 1, wherein the geometrical relationship includes a relative angular position of the two discrete sets of pixels in the document.

5. The method of claim 4, wherein the angular position is selected from the group including horizontal position, vertical position, and combination thereof.

6. The method of claim 1, further comprising:
representing the symbol of the message using intensities of each pixel in the two discrete sets of pixels.

7. The method of claim 1, further comprising:
selecting the glyph from a set of glyphs of the document, such that the glyph is suitable for embedding the symbol.

8. The method of claim 7, wherein a shape of the glyph has at least one stroke having a length of at least l pixels and a width of at least w pixels.

9. The method of claim 1, wherein combining further comprising:
mapping intensities of corresponding pixels associated with the glyph to intensities of pixels from the two discrete sets of pixels.

10. The method of claim 9, wherein the corresponding pixels are internal to a shape of the glyph.

11. The method of claim 9, wherein the corresponding pixels are external to a shape of the glyph.

12. The method of claim 9, wherein the corresponding pixels border an edge of a vertical stroke the glyph.

13. The method of claim 9, wherein the corresponding pixels border an edge of a horizontal stroke the glyph.

14. The method of claim 1, further comprising:
detecting the two discrete sets of pixels embedding the symbol in the modified glyph; and
determining the symbol of the message based on the geometrical relationship of the two discrete sets of pixels.

15. The method of claim 1, further comprising:
inserting in the message at least one packetization symbol.

16. The method of claim 15, wherein the packetization symbol is selected from the group including begin packet symbol, packet number symbol, and synchronization symbol.

17. A document stored on a readable media, the document including an embedded message, comprising:
a glyph rendered on a document; and
at least two discrete sets of pixels combined with pixels associated with the glyph rendered on the document, such that a geometrical relationship of the two discrete sets of pixels is suitable for extracting a symbol of a message embedded in the document.

18. The document of claim 17, wherein the document is in a hard-copy form.

19. The document of claim 17, wherein the document is printed on a paper.
